(19) United States
(12) Patent Application Publication
(10) Pub. No.: US 2004/0094097 A1
(43) Pub. Date: May 20, 2004

(54) Litter box ventilation system

(76) Inventor: Stephen Paul Shartell, Farmington Hills, MI (US)

Correspondence Address: Stephen Shartell, PO Box 3318, Farmington Hills, MI, 48333, US

(21) Appl. No.: 10/704,848

(22) Filed: Nov. 10, 2003

Related U.S. Application Data
(60) Provisional application No. 60/425,492, filed on Nov. 12, 2002.

(51) Int. Cl. A01K 29/00

(52) U.S. Cl. 119/165

(57) ABSTRACT

There are many types of litter box ventilation systems of varying forms which utilize flexible hoses and often specify vague designs regarding the blower units or how they may attached to or disconnect from a litter box. Many are cumbersome to use and some require an open window to operate. This application describes and illustrates a litter box ventilation system without these problems. This invention was created for the purpose of preventing up to 100% of the odors, germs, and allergens, produced in the litter box from entering the home and moving them to the outdoors 24 hours a day by way of an electrically driven ventilation unit assembly that is not cumbersome to use and doesn't require major construction or alterations to the home to install and does not look aesthetically distracting or displeasing.

### CROSS-REFERENCE TO RELATED APPLICATIONS

This application is based upon provisional application No. 60/425,492 filed on Nov. 12, 1902.

| | | | |
|---|---|---|---|
| 4,095,559 | June 1978 | Griffith | 119/165 |
| 4,522,150 | June 1885 | Gershman | 119/19 |
| 5,140,948 | August 1992 | Roberts | 119/165 |
| 5,655,478 | August 1997 | Kiera | 119/165 |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK

Not Applicable

### BACKGROUND OF INVENTION

There are many litter box ventilation system designs which utilize flexible hoses and often specify vague designs regarding the ventilation units and how they may or may not disconnect from a litter box. Many are cumbersome to use and some require an open window to operate. This application describes and illustrates a litter box ventilation system that is easy to use, and without the problems listed in this paragraph.

### BRIEF SUMMERY OF THE INVENTION

This invention relates to the ventilating a covered style cat litter box for the purpose of preventing up to 100% of the odors, germs, and allergens, produced in the litter box from entering the home and moving them to the outdoors.

### BRIEF DESCRIPTION OF THE SEVERAL VIEWS OF THE DRAWINGS

FIG. 1 shows the ventilation unit assembly attached to the wall.

FIG. 2 shows the litter box attached to the ventilation unit assembly.

FIG. 3 is a breakdown of the ventilation unit assembly.

FIG. 4 shows an open rear view of the ventilation unit assembly.

FIG. 5 and FIG. 6 shows the point where the litter box connects to the ventilation unit assembly.

FIG. 7 is a cutaway showing how the male vacuum connector is secured to the litter box cover.

FIG. 8 shows the ventilation pipe terminating outside the home.

### DETAILED DESCRIPTION OF THE INVENTION

U.S. Pat. No. 4,095,559 to Griffith discloses an electrically ventilated cat litter box. Additional patents have been granted for litter box ventilation systems of varying forms which utilize flexible hoses and often specify vague designs regarding the blower units or how they may attached to or disconnect from a litter box. Many are cumbersome to use and some require an open window to operate.

This invention was created for the purpose of preventing up to 100% of the odors, germs, and allergens, produced in the litter box from entering the home and moving them to the outdoors 24 hours a day by way of an electrically driven ventilation unit that is not cumbersome to use and doesn't require major construction or alterations to the home to install and does not look aesthetically distracting or displeasing.

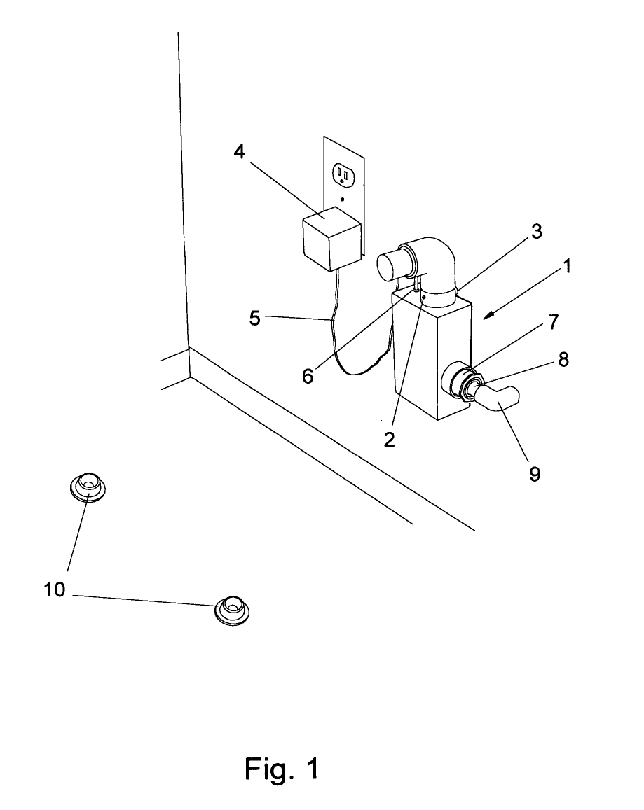

FIG. 1 illustrates the ventilation unit assembly (1) (one component of the ventilation system) on a wall adjacent to the outdoors with the ½″ (or larger) ventilation pipe (8,9) directed through the wall to the outdoors. A reducer (7) is used to attach the pipe to the unit. The unit (1) is powered by an AC to DC Adapter (4) which is connected to the unit by a 2-lead cord (5) and a male electrical connector (6). Two long screws (2) are used (one is at the bottom out of view) to anchor the ventilation unit assembly (1) to the wall and two spacers (3) are used (one is at the bottom out of view), allowing the unit to be secured properly to the wall. Two self adhesive door stoppers (10) are attached to the floor in front of the unit to prevent the litter box from sliding in a right or left direction when it is attached to the ventilation unit assembly (1).

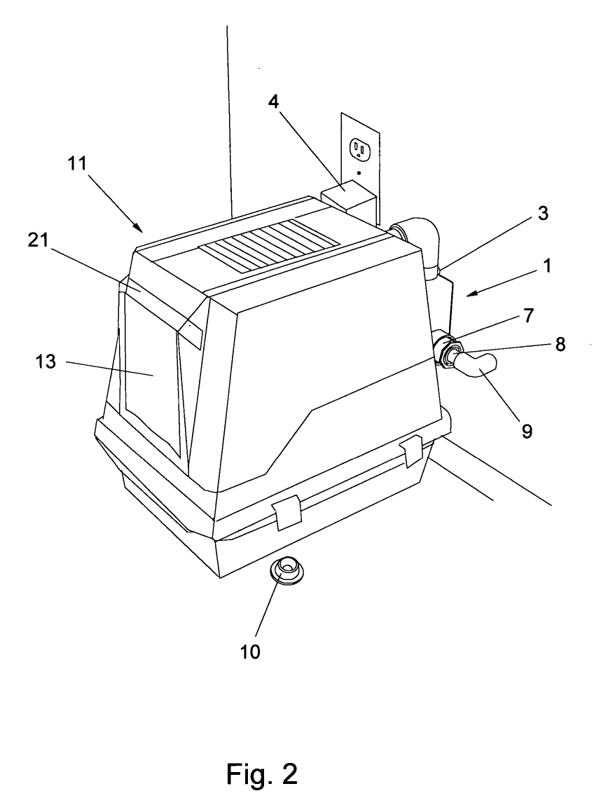

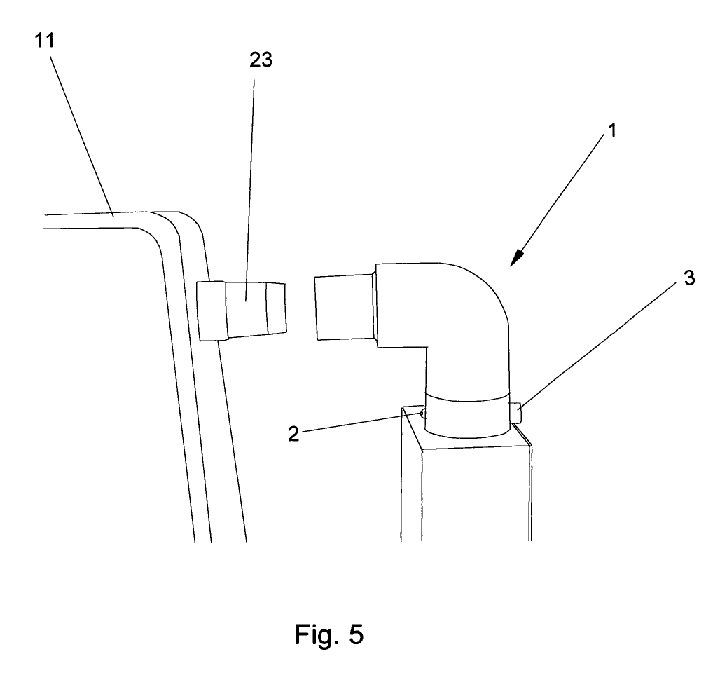

FIG. 2 is the same view as FIG. 1 except for the fact that it shows the covered litter box (11), which is positioned between the door stoppers (10), attached to the ventilation unit assembly (1) by way of a vacuum fitting (23) (illustrated in FIGS. 5-7) which protrudes from the rear of the litter box (11). The fitted soft plastic transparent door curtain (13) attached to the litter box (11) with strapping tape (21) is also illustrated.

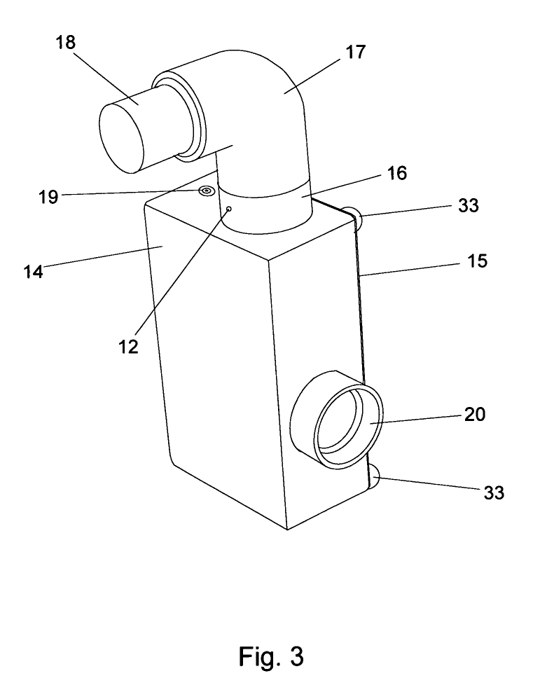

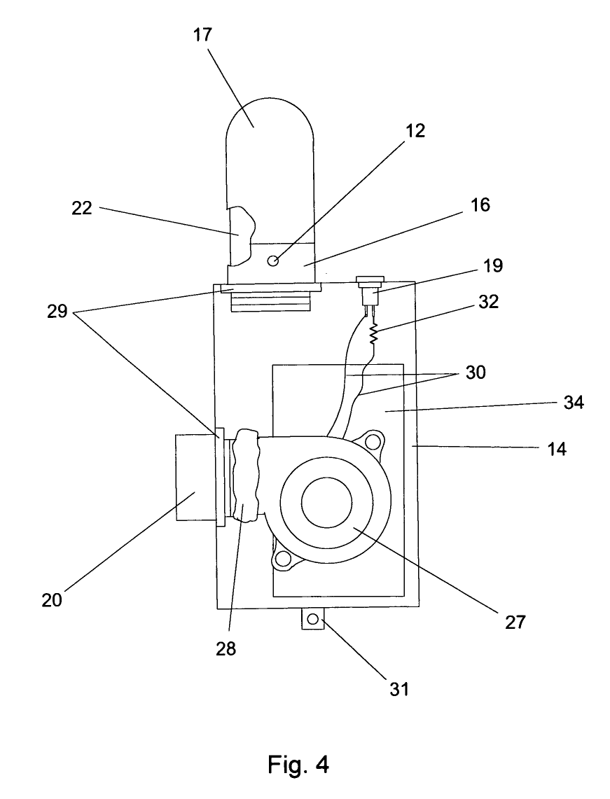

FIG. 3 is a breakdown of the ventilation unit assembly (1) (one component of the ventilation system). The ventilation unit assembly is comprised of a plastic enclosure box (14) with an access cover plate (15) on the back. The enclosure box has three holes for two PVC male adapters (16,20) and one female electrical connector (19). A PVC elbow (17) is secured to the top PVC adapter (16) with a section of PVC pipe (see FIG. 4—(22)) and PVC cement. The large end of a female vacuum hose fitting (18) is inserted into the open end of the PVC elbow (17) and secured with PVC cement. A screw hole (12) is drilled through the male adapter (16), which are used to secure the unit to the wall. A female electrical connector (19) is attached to the enclosure box (14) through the small hole at the top. The external structure of the ventilation unit assembly (14,16,17,20) can also be constructed of a single molded piece of plastic, with inlets for the vacuum fitting (18), electrical connector (19) screws (2) (see FIG. 5), and PVC pipe or reducer (7) (see FIG. 1). Five felt pads (33) (two are shown) are attached to the access cover plate (15) to keep the entire back of the unit from being pressed against the wall so as to prevent vibration transfer and reduce noise. The ventilation unit assembly (1), use with a slightly different hardware configuration, can also be use to efficiently ventilate toilets bowls, providing the same benefits of odor removal as it does with litter boxes.

FIG. 4 shows an open rear view of the ventilation unit assembly. (1) with the access cover plate (15) (see FIG. 3) off. The ventilation unit assembly is comprised of a plastic enclosure box (14). The enclosure box has three holes for two PVC male adapters (16,20) and one female electrical connector (19). Each PVC adapter is secured to the inclosure box by a conduit lock-nut (29). A PVC elbow (17) is secured to the top PVC adapter (16) with a section of PVC pipe (22) and PVC cement. A screw hole (12) is drilled through the male adapter (16), which is used to secure the unit to the wall. There is also an “L” shaped bracket (31) at the bottom of the ventilation unit assembly used to secure the unit to the wall. A female electrical connector (19) is attached to the enclosure box through the small hole at the top. A small blower fan (27) inside the plastic enclosure box is attached to the lower PVC adapter (20) with silicone (28), which supports the blower fan, produces an airtight seal, and absorbs noise and vibration. The blower fan (27) is connected in series to the female electrical connector (19) and a resistor (32), used for speed control, by two wire leads (30). Rectangle felt pads (34) are attached to the inside of the enclosure box further reducing noise and vibration.

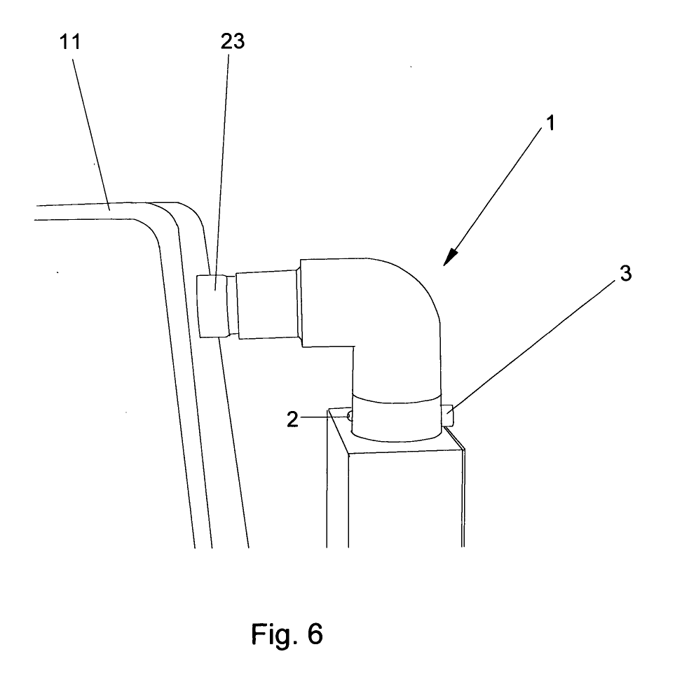

FIG. 5 illustrates the point where the litter box (11) connects to the ventilation unit assembly (1). The illustration shows the system in an open or non-connected position. A male vacuum connector (23) protruding from the center upper rear of the litter box (11) easily slides into the top inlet (the female vacuum connector) of the ventilation unit assembly (1) when the litter box (11) is pushed toward the ventilation unit assembly (1) as illustrated in FIG. 6.

FIG. 6 illustrates the point where the litter box (11) connects to the ventilation unit assembly (1). The illustration shows the system in a closed or connected position. A male vacuum connector (23) protruding from the center upper rear of the litter box (11) is connected to the top (the female vacuum connector) of the ventilation unit assembly (1). This provides an airtight connection between the litter box (11) and the ventilation unit assembly (1), allowing the ventilation unit assembly to continuously draw air from the inside of the litter box. The litter box (11) is disconnected from the ventilation unit assembly (1) by sliding the litter box (11) away from the ventilation unit assembly (1).

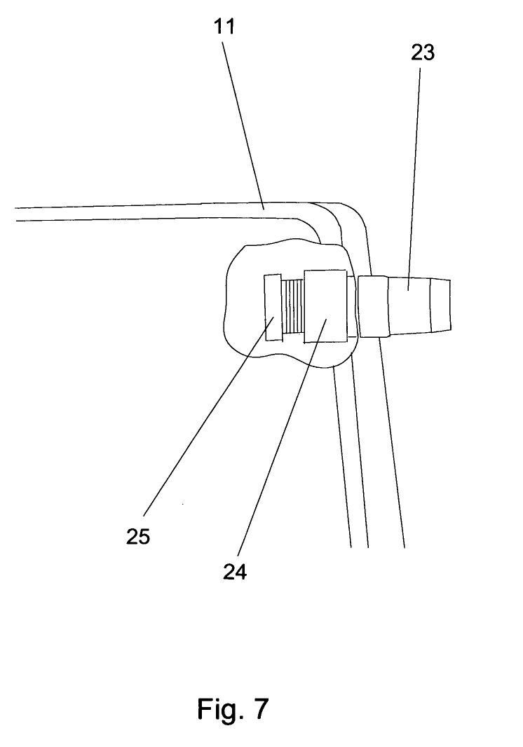

FIG. 7 This cut away illustration shows how the male vacuum connector (23) is secured to the litter box (11). A hole is drilled in the center upper rear area of the litter box. After the male vacuum connector is placed part way through the hole, a PVC adapter (24) is secured to the vacuum connector (23) inside the litter box. A cap (25) which holds a screen is screwed on to the PVC adapter (24).

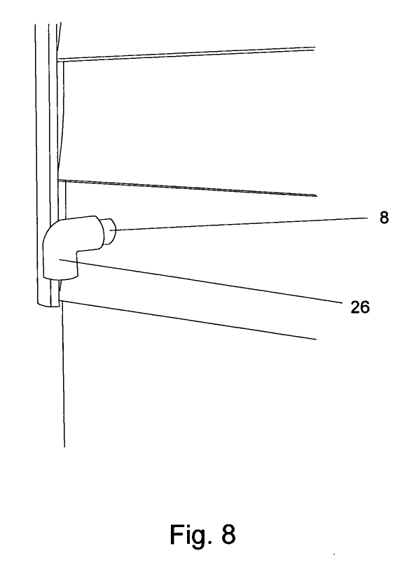

FIG. 8 shows the ventilation pipe (8) terminating outside the home. A PVC elbow (26) with a screen covering one opening is attached to the ventilation pipe (8), causing a screened opening to face downward, preventing rain and insects from entering.

This application describes and illustrates a litter box ventilation system with a ventilation unit assembly that attaches to a specific area on the wall behind the litter box. This allows the ventilation unit assembly to be hidden behind the litter box. When attached to the ventilation unit assembly, the litter box sits only 4 inches from the wall. This is due to the fact that the ventilation unit assembly is small and does not consume an excessive amount of space. This system uniquely utilizes vacuum connectors which allow the litter box to be easily connected to the ventilation unit assembly and to create an airtight connection between the litter box and the ventilation unit assembly. A male vacuum connector permanently attached to and protruding from the upper rear of the litter box cover easily slides into a female vacuum connector which protrudes from the top of the ventilation unit assembly toward the litter box in a horizontal fashion. When the connectors are lined up, the litter box is pushed toward the ventilation unit assembly until the connectors are connected, which creates an airtight connection between the litter box and the ventilation unit assembly. The litter box disconnects from the ventilation unit assembly by simply pulling the litter box away from the ventilation unit assembly causing the vacuum connectors to disconnect from each other. The litter box is reattached to the ventilation unit assembly by placing it in front of the ventilation unit assembly, lining up the vacuum connectors, and sliding the litter box toward the ventilation unit assembly until the vacuum connectors are connected. This ease of use is a significant feature of this system. The unit never needs to be turned off and is maintenance free.

The ventilation unit assembly is comprised of a plastic enclosure box with three holes for two PVC male adapters and one female electrical connector. A small blower fan inside the plastic enclosure box is attached to the lower PVC adapter with silicone, which produces a sturdy and supportive airtight seal and reduces noise and vibration. Round felt pads are attached to the back cover plate and rectangle felt pads are attached to the inside if the enclosure box further reducing noise and vibration. The PVC adapter at the top of the ventilation unit assembly connects to the intake arm made up of a PVC pipe, a PVC elbow, and a female vacuum connector. The lower PVC adapter on the side of the ventilation unit assembly connects to a reducer which connects to a ventilation pipe made up of PVC pipe as small as ½″ which leads to the outdoors. Using this small diameter pipe allows for ventilating to the outdoors without drilling large holes, removing dry wall, or otherwise altering the home in any major way. If there is no way to put the pipe into the wall, this type and size of pipe can be run along baseboards in most areas where litter boxes are placed to reach an outside wall. The hole that is drilled in an outside wall to put the pipe through can be less than 1″ in diameter. Larger PVC pipe can be used for the ventilation pipe if the pipe needs to be extremely long. The ventilation pipe terminates outside the home with a PVC elbow causing the outlet hole to be directed downward. The outlet hole is covered by aluminum screen. A backdraft preventer can also be used at this location.

The external structure of the ventilation unit assembly including the plumbing fixtures can also be constructed of a single molded piece of plastic, with inlets for the vacuum fitting, electrical connector, and PVC pipe or reducer. The ventilation unit assembly, use with a slightly different hardware configuration, can also be use to efficiently ventilate toilets bowls, providing the same benefits of odor removal to that device as it does with litter boxes.

The ventilation unit assembly is powered by an AC to DC adapter which plugs into any standard outlet and is connected to the ventilation unit assembly by way of a 2 wire cord and a male electrical connector. This male electrical connector connects to a female electrical connector at the top of the ventilation unit assembly. The blower fan inside the ventilation unit assembly is also connected to the female electrical connector by two wire leads. There may be a resistor or electronic circuit in series with the blower for speed control. The total power consumption of the ventilation unit assembly is approximately 5 watts of electrical power while the unit is running. This low power, efficient device is meant to operate 24 hours a day, providing for continuous ventilation of odors, germs, and allergens, produced by material inside the litter box, to the outdoors.

A soft transparent fitted sheet of plastic is attached to the top of the litter box entrance and is draped over the entrance to increase the ventilation unit assembly's ability to prevent odors, germs, and allergens, produced in the litter box from entering the home. An additional sheet of fitted transparent plastic is used to cover the vent holes at the top of the litter box. The plastic sheets are attached to the litter box with strapping tape. Two long screws are used to secure the ventilation unit assembly to the wall behind the litter box. The ventilation unit assembly must be placed at the correct height so the male and female vacuum connector fittings will be lined up so they will easily fit together and create an airtight connection.

A circular rubber self adhesive door stopper (or a smaller bumper) is attached to the floor on each side of the litter box near the front of the litter box to prevent the litter box from sliding too far in a right or left direction while the litter box is attached to the ventilation unit assembly, which may cause damaged to the litter box or the ventilation unit assembly.

I claim:

1. A litter box ventilation system, carrying up to 100% of odors, germs, and allergens in a litter box to the outdoors, compromising in combination a ventilation unit assembly attached to a wall at the correct height equipped with a small PVC vent pipe to the outdoors and an intake arm with a female vacuum connector at the end, as well as a male vacuum connector permanently attached to a litter box cover, which is part of a litter box assembly, providing continuous ventilation of a covered litter box to the outdoors.

2. The litter box ventilation system of claim 1, wherein the litter box easily connects to the ventilation unit assembly in that a female vacuum connector attached to the intake arm of the ventilation unit assembly is made to connect to a male vacuum connector permanently attached to a litter box cover whereby aligning the connectors and moving the litter box towards the ventilation unit assembly until a connection is made, providing an airtight connection between the litter box and the ventilation unit assembly, and disconnecting by pulling said litter box away from the ventilation unit assembly.

3. The litter box ventilation system of claim 1, wherein the system operates quietly in that the blower operates at low speed and is mounted into the unit with silicone only, in addition to round felt pads attached to the back cover plate and rectangle felt pads which are attached to the inside if the enclosure box.

4. The litter box ventilation system of claim 1, wherein no major alterations to a home are needed for installation in that the system can operate with a PVC vent pipe less than 1″ wide.

5. The litter box ventilation system of claim 1, wherein it can be operated 24 hours a day in that noise levels and electricity use is low, system is maintenance free, and unit can remain on while litter box is disconnected from the ventilation unit assembly.

6. A ventilation unit assembly, wherein it can be used independently with a dissimilar hardware configuration to produce the aforesaid results regarding odors whereas being used to ventilate toilet bowls as with litter boxes.
